(19) United States
(12) Patent Application Publication
(10) Pub. No.: US 2025/0306180 A1
(43) Pub. Date: Oct. 2, 2025

(54) LIDAR AND ALIGNMENT METHOD OF THE LIDAR

(71) Applicant: HESAI TECHNOLOGY CO., LTD., Shanghai (CN)

(72) Inventors: Dingcheng ZHAO, Shanghai (CN); Ji WANG, Shanghai (CN); Shaoqing XIANG, Shanghai (CN)

(73) Assignee: HESAI TECHNOLOGY CO., LTD., Shanghai (CN)

(21) Appl. No.: 19/237,189

(22) Filed: Jun. 13, 2025

Related U.S. Application Data
(63) Continuation of application No. PCT/CN2023/138782, filed on Dec. 14, 2023.

(30) Foreign Application Priority Data
Dec. 14, 2022 (CN) 202211608944.8

(51) Int. Cl. G01S 7/481

(52) U.S. Cl. CPC G01S 7/4817; G01S 7/4811

(57) ABSTRACT

A LiDAR includes a substrate, an installing base, an emission lens barrel, a receiving lens barrel, and a scanner. The substrate includes an emitter arranged on a surface of the substrate emitting a detection beam and a receiver arranged on the same surface for receiving an echo beam. The installing base includes a first optical channel and a second optical channel, isolated from each other. The first and second optical channels are configured to penetrate through a first end and a second end of the installing base. The detection beam and echo beam pass through the first and second channels, respectively. The first end is configured to fixedly connect to the substrate. The emission lens barrel is connected to the second end. The receiving lens barrel is connected to the second end. The scanner is configured to adjust directions of the detection beam and the echo beam.

### CROSS-REFERENCE TO RELATED APPLICATION(S)

This application is a continuation application of copending International Patent Application No. PCT/CN2023/138782, filed on Dec. 14, 2023, which claims priority to Chinese Patent Application No. 202211608944.8, filed on Dec. 14, 2022, the content of which is incorporated herein by reference in its entirety.

### TECHNICAL FIELD

The embodiments of this disclosure relate to the field of LiDAR technology, in particular to LiDARs and alignment methods of the LiDAR.

### BACKGROUND

A LiDAR is a sensing sensor that detects the environment actively. The LiDAR can emit a detection beam towards an object (e.g., a target object), and an echo beam can be generated after the detection beam is diffusely reflected at the object. The LiDAR can generate point cloud data by receiving the reflected echo beam. Relevant information about the object can be obtained based on the point cloud data, and a time of flight (“ToF”) of emitting and receiving laser beams.

A rotating mirror type LiDAR can include an emission lens module (e.g., an emission lens module includes an emission lens, an emission reflective mirror, an emission lens barrel, or the like), a receiving lens module (e.g., a receiving lens includes a receiving lens, a receiving reflective mirror, a receiving lens barrel, or the like), a rotating mirror module, an emitter module, and a receiver module. The emission lens module and the receiving lens module can be non-axisymmetric and complex structural components. The structural component can be processed integrally. Most of the optical positioning surfaces (e.g., a lens positioning surface, a reflective mirror positioning surface, or the like) can be inside the lens barrel. The structure of the lens barrel is complex and the processing precision of the optical positioning surfaces is relatively poor. The optical performance can exhibit fluctuations. In addition, the emission lens module and the receiving lens module are non-axisymmetric structures due to deflection of dual reflective mirror. The emission lens module and the receiving lens module can be difficult to be manufactured. The stability of the optical performance of the LiDAR can be decreased or not be guaranteed. The manufacturing costs can increase, which is not beneficial for mass production. When adjusting the LiDAR by aligning the emitter and receiver, the position of the emitter module or receiver module needs to be adjusted. A movable space can be reserved for the emitter module or receiver module. The emitter module or receiver module can be in less close contact with the structural components. Poor heat dissipation performance can be caused.

### SUMMARY

The embodiments of this disclosure provide LiDARs and alignment methods of the LiDAR. The structure of the LiDAR can be simplified. The stability of the optical performance can be improved.

In a first aspect, this disclosure provides a LiDAR. The LiDAR includes a substrate, an installing base, an emission lens, a receiving lens, a scanner, and a first reflective mirror. The substrate includes an emitter module and a receiver module arranged on a same surface of the substrate. The emitter module is configured to emit a detection beam. The receiver module is configured to receive an echo beam generated after the detection beam is reflected by an object. The installing base includes a first optical channel and a second optical channel. The first optical channel and the second optical channel are isolated from each other. The first optical channel and the second optical channel penetrate through a first end and a second end of the installing base, respectively. The substrate is fixedly connected to the first end of the installing base. The emission lens module is arranged in the first optical channel and corresponding to the emitter module. The emission lens module is configured to collimate the detection beam. The receiving lens module is arranged in the second optical channel and corresponding to the receiver module. The receiving lens module is configured to shape the echo beam. The scanner module is configured to change angles of the detection beam and the echo beam incident upon the scanner module. The first reflective mirror module is arranged at the second end of the installing base. The first reflective mirror module is configured to change a transmission direction of the detection beam collimated by the emission lens module to deflect the detection beam to the scanner module, and change a transmission direction of the echo beam deflected by the scanner module to deflect the echo beam to the receiving lens module.

Optionally, the first reflective mirror module includes: a first installing bracket, a first partial reflective mirror, and a first receiving reflective mirror. The first installing bracket is arranged at the second end of the installing base and includes a hollow channel through which the echo beam passes. The first partial reflective mirror is arranged on a first side of the first installing bracket and is configured to change the transmission direction of the detection beam collimated by the emission lens modules to deflect the detection beam to the scanner module, and allow the echo beam to pass through to transmit the echo beam to the first receiving reflective mirror. The first receiving reflective mirror is arranged on a second side of the first installing bracket and is configured to change the transmission direction of the echo beam to deflect the echo beam to the receiving lens module. The first side and the second side are opposite sides of the first installing bracket.

Optionally, the first reflective mirror module includes: a second installing bracket, a second partial reflective mirror, a third installing bracket, and a second receiving reflective mirror. The second installing bracket is arranged at the second end of the installing base and includes a first hollow structure through which the detection signal passes. The second partial reflective mirror is arranged at the second end of the installing base and is configured to change the transmission direction of the detection beam collimated by the emission lens modules to deflect the detection beam to the scanner module, and allow the echo beam to pass through to transmit the echo beam to the second receiving reflective mirror. The third installing bracket is arranged at the second end of the installing base and has a second hollow structure through which the echo beam passes. The second receiving reflective mirror is arranged at one end of the second hollow structure away from the substrate and is configured to change the transmission direction of the echo beam to deflect the echo beam to the receiving lens module.

Optionally, the installing base further includes a third end, and the first optical channel and the second optical channel simultaneously penetrate through the first end, the second end and the third end of the installing base.

The LiDAR further includes: a second reflective mirror module arranged at the third end of the installing base. The second reflective mirror module is configured to change the transmission direction of the detection beam emitted by the emitter module to deflect the detection beam to the emission lens module, and change the transmission direction of the echo beam shaped by the receiving lens module to deflect the echo beam to the receiver module.

Optionally, the emission lens module and the receiving lens module are fixedly connected to the second end of the installing base.

Optionally, the emission lens module includes: an emission lens, an emission lens barrel. The emission lens is corresponding to the emitter module and configured to collimate the detection beam. The emission lens barrel has an axisymmetric structure and is configured to fix the emission lens. The emission lens barrel has a first protrusion structure on an outer circumference of the emission lens barrel.

Optionally, the second end of the installing base is further provided with a first groove structure provided circumferentially on an inner wall of an end of the first optical channel. The first groove structure cooperates with the first protrusion structure to position the emission lens barrel inside the first optical channel.

Optionally, the receiving lens module includes a receiving lens, a receiving lens barrel. The receiving lens is corresponding to the receiver module and configured to shape the echo beam. The receiving lens barrel has an axisymmetric structure and is configured to fix the receiving lens. The receiving lens barrel has a second protrusion structure on an outer circumference or the receiving lens barrel.

Optionally, the second end of the installing base is further provided with a second groove structure provided on an inner wall of an end of the second optical channel. The second groove structure cooperates with the second protrusion structure to position the receiving lens barrel inside the second optical channel.

Optionally, a first adjustable gap is provided between the emission lens module and a side wall of the first optical channel; and/or a second adjustable gap is provided between the receiving lens module and a side wall of the second optical channel.

Optionally, a size of the substrate in an extension direction of the surface is larger than a cross section size of the first end of the installing base.

Some embodiments of this disclosure also provide an alignment method for a LiDAR. The LiDAR includes a substrate, an installing base, an emission lens module, a receiving lens module, a scanner module, and a first reflective mirror module. The substrate includes an emitter module and a receiver module arranged on a same surface of the substrate. The installing base includes a first optical channel and a second optical channel. The first optical channel and the second optical channel are isolated from each other. A first adjustable gap is provided between the emission lens module and a side wall of the first optical channel; and/or a second adjustable gap is provided between the receiving lens module and a side wall of the second optical channel. The alignment method includes: a relative position between the emission lens module and the first optical channel being adjusted to direct an echo beam to a preset position of the receiver module; and/or a relative position of the receiving lens module and the second optical channel being adjusted to direct the echo beam to the preset position of the receiver module.

Optionally, the LiDAR includes a substrate, an installing base, an emission lens module, a scanner module, a receiving lens module, and a first reflective mirror module. The substrate includes an emitter module and a receiver module arranged on a same surface of the substrate. The installing base including a first optical channel and a second optical channel. The first optical channel and the second optical channel are isolated from each other. The first reflective mirror module includes a second installing bracket, a second partial reflective mirror, a third installing bracket, and a second receiving reflective mirror. The alignment method includes: a position and attitude of the second installing bracket relative to the installing base and/or a position and attitude of the second partial reflective mirror relative to the second installing bracket being adjusted, to direct an echo beam to a preset position of the receiver module; and/or a position and attitude of the third installing bracket relative to the installing base and/or a position and attitude of the second receiving reflective mirror relative to the third installing bracket being adjusted, to direct the echo beam to the preset position of the receiver module.

In some embodiments, the emitter module and the receiver module can be simultaneously arranged on the same surface of the substrate. An integrated design of the receiver module and the emitter module can be realized. Through a high precision mounting process of the circuit board, it can be improved or ensured that the emitter module and the receiver module are precisely positioned at the preset positions. When performing alignment of the LiDAR by aligning the emitter and receiver, the alignment of emitter and receiver can be achieved by adjusting the emission lens module and/or the receiving lens module and/or the first reflective mirror module instead of adjusting positions of the emitter module and the receiver module. There is no need to reserve a movable space for the emitter module and the receiver module, and both the emitter module and the receiver module can be directly in close contact with the heat dissipation structural component, which is beneficial for heat dissipation. Arranging the emitter module and the receiver module on the same substrate can not only reduce the number of substrates used but also reduce the design difficulty of the heat dissipation structural component and the complexity in spatial layout of the heat dissipation structural components, thereby simplifying the structure of the LiDAR.

In some embodiments, the emission lens module, the receiving lens module and the first reflective mirror module are separated. The emission lens module, the receiving lens module and the first reflective mirror module can be integrally assembled through the installing base respectively. The complex lens barrel structure is no longer required. The emission lens module and the receiving lens module can be designed as having an axisymmetric structure. By doing so, the emission lens module and the receiving lens module are easy to realize higher processing precision through turning processing or the like. Better and more stable optical performance can be obtained. The first optical channel and the second optical channel of the installing base can also be designed as axisymmetric structures, which reduces the processing difficulty of the LiDAR. By separately arranging the emission lens module, the receiving lens module and the reflective mirror module, the alignment of the emitter and receiver of the LiDAR can be realized by adjusting at least one of the emission lens module, the receiving lens module and the reflective mirror module. The first optical channel and the second optical channel of the installing base are isolated from each other. Crosstalk between the detection beam and the echo beam can be decreased or avoided. The stability of the optical performance can be improved.

In some embodiments, the first reflective mirror module can install the first partial reflective mirror and the second reflective mirror. Optionally, the first reflective mirror module can include the first installing bracket molded in one piece. Optionally, the first reflective mirror module can include a second installing bracket and a third installing bracket designed in separate pieces. The optical installing surfaces of the first partial reflective mirror and the second reflective mirror on any of the installing bracket structural components are provided at the outer sides of the installing bracket. Compared with solution where the optical installing surfaces are provided inside the lens barrel. High precision processing is easy to achieve. The processing difficulty can be reduced.

In some embodiments, protrusion structures are designed on the outer circumference of the emission lens barrel and the receiving lens barrel. The emission lens barrel and the receiving lens barrel can be easily snapped into and positioned to the installing base. The assembly can be facilitated.

In some embodiments, a first adjustable gap is provided between the emission lens module and the first optical channel, and/or a second adjustable gap is provided between the receiving lens module and the second optical channel. The LiDAR can be conveniently assembled and adjusted during actual installing process. Time required for assembly of the LiDAR can be reduced. The alignment of the emitter and receiver of the LiDAR can be achieved by adjusting the position of the emission lens module in the first optical channel and/or the position of the receiving lens module in the second optical channel.

In some embodiments, the size of the substrate in an extension direction of the surface is larger than the cross-section size of the end face of the installing base. The substrate can form an enclosed environment with the first optical channel and the second optical channel. The detection beam emitted by the emitter module can be transmitted to the emission lens module and the echo beam can be completely transmitted to the receiving lens module. Loss of the detection beam and the echo beam during the detection can be reduced. Detection efficiency and accuracy can be improved.

### BRIEF DESCRIPTION OF THE DRAWINGS

To more clearly describe the technical solutions in some embodiments of this disclosure, an introduction of the drawings to be used in describing some embodiments are provided as follows. The drawings described below are only embodiments of this disclosure. For those skilled in the art, other drawings can also be obtained based on the drawings provided without creative work.

FIG. 1 shows a schematic diagram illustrating a profile structure of an example LiDAR, consistent with some embodiments of this disclosure.

FIG. 2 shows a schematic diagram illustrating an example explosion structure of the example LiDAR of FIG. 1, consistent with some embodiments of this disclosure.

FIG. 3 shows a schematic diagram illustrating a profile structure of another example LiDAR, consistent with some embodiments of this disclosure.

FIG. 4 shows a schematic diagram illustrating an explosion structure of the another example LiDAR of FIG. 3, consistent with some embodiments of this disclosure.

FIG. 5 shows a schematic diagram illustrating a profile structure of another example LiDAR, consistent with some embodiments of this disclosure.

FIG. 6 shows a schematic diagram illustrating an explosion structure of another example LiDAR of FIG. 5, consistent with some embodiments of this disclosure.

FIG. 7 shows a schematic diagram illustrating an example alignment of a LiDAR, consistent with some embodiments of this disclosure.

FIG. 8 shows a schematic diagram illustrating another example alignment of LiDAR, consistent with some embodiments of this disclosure.

### DETAILED DESCRIPTION

As described in the background section, the emitter module and the receiver module of example LiDAR can be separately arranged on different circuit boards. The structure of the LiDAR can be complex.

To solve the above technical problem, some embodiments of this disclosure provide a LiDAR. The emitter module and receiver module of the LiDAR can be both arranged on the same surface of the same substrate. An integrated design of the receiver module and emitter module can be realized. Through a high precision mounting process of the circuit board, it can be improved or ensured that the emitter module and receiver module are precisely positioned at preset positions. The separate components including substrate, emission lens module, receiving lens module, and first reflective mirror module can be integrally assembled by the installing base respectively. A structure of emission lens module and the receiving lens module can be axisymmetric. An optical installing surface in the first reflective mirror module can be located outside a structural component of the first reflection module. The emission lens module, the reception lens module, and the first reflective mirror module can be manufactured through high-precision and low-difficulty processing. The stability of optical performance of the LiDAR can be improved, and the overall cost can be effectively reduced. The emission lens module, the receiving lens module and the first reflective mirror module can be separated. During an alignment process of aligning a receiver and an emitter, reflective mirror the emission lens module, the receiving lens module and the first reflective mirror module can be independently adjusted to realize alignment of the receiver and the emitter. The alignment process is simple, and there is no need to adjust the positions of the emitter module and the receiver module. There is no need to reserve a movable space for the emitter module and the receiver module, and the emitter module and the receiver module can be directly and closely attached to a heat dissipation structural component, which is beneficial for heat dissipation.

To make the above objects, features, and advantages of some embodiments of this disclosure more apparent and understandable, detailed description of the LiDAR involved in some embodiments of this disclosure are provided through some embodiments as follows.

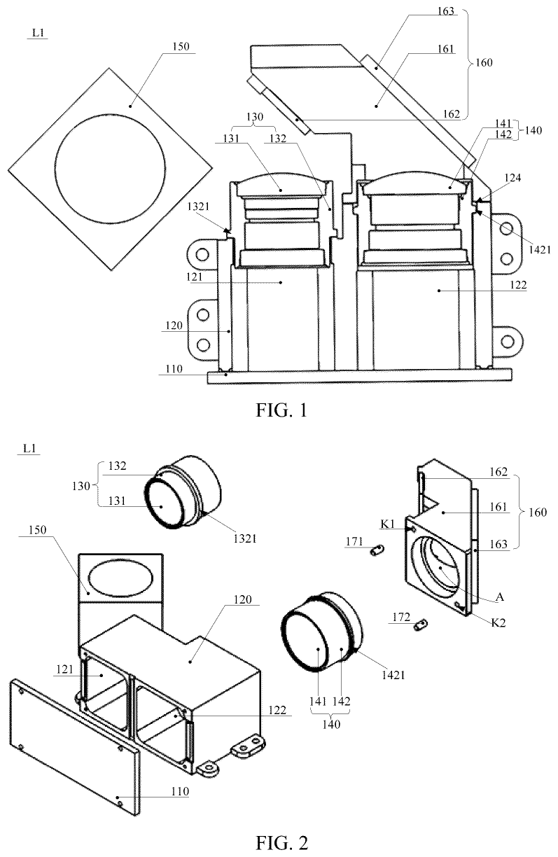

Referring to FIGS. 1-8, in some embodiments of this disclosure, the LiDAR includes a substrate 110, an installing base 120, an emission lens module 130, a receiving lens module 140, a scanner module 150, and a first reflective mirror module 160 (or a first reflective mirror module 260).

The substrate 110 can include an emitter module and a receiver module (not shown in FIG. 1-8) arranged on a same surface of the substrate 110. The emitter module can emit a detection beam, and the receiver module can receive an echo beam generated after the detection beam is reflected by an object.

The installing base 120 includes a first optical channel 121 and a second optical channel 122. The first optical channel 121 and the second optical channel 122 are isolated from each other. The first optical channel 121 and the second optical channel 122 penetrates through a first end and a second end of the installing base 120. The substrate 110 is fixedly connected to the first end of the installing base 120.

The emission lens module 130 is arranged in the first optical channel 121 and corresponding to the emitter module. The emission lens module 130 can collimate the detection beam.

The receiving lens module 140 is arranged in the second optical channel 122 and corresponding to the receiver module. The receiving lens module 140 can shape the echo beam.

The scanner module 150 can change angles of the detection beam and the echo beam incident upon the scanner module 150.

The first reflective mirror module 160, 260 can be arranged at the second end of the installing base 120. The first reflective mirror module can change a transmission direction of the detection beam collimated by the emission lens module 130 to deflect the detection beam to the scanner module 150. The first reflective mirror module can change a transmission direction of the echo beam deflected by the scanner module 150 to deflect the echo beam to the receiving lens module 140.

In some embodiments, when the LiDAR is in operation, the emitter module can emit a detection beam. The detection beam can be collimated by the emission lens module 130. The detection beam can be emitted towards the external environment after successive deflection through the first reflective mirror module 160, 260 and the scanner module 150. When the detection beam detects an object, a surface of the object can reflect an echo beam corresponding to the detection light signal. The echo beam can propagate along a preset optical path. After a first deflection on the scanner module 150, the echo beam can incident upon the first reflective mirror module 160, 260. After a second deflection on the first reflective mirror module 160, 260, the echo beam can incident upon the receiving lens module 140. The receiving lens module 140 can shape the echo beam and deflect the echo beam to the receiver module. A detection process can complete.

To make those skilled in the art to better understand and implement the technical solution of some embodiments of this disclosure, some examples are given as follows for some example implementation of the LiDAR in some embodiments of this disclosure.

In some embodiments, the substrate 110 can include a printed circuit board (“PCB”), or the like. The substrate 110 can integrate multiple circuits, such as driving circuits, power circuits, processing circuits, control circuits, or the like. The emitter module and the receiver module can be arranged on a same surface of the substrate 110. The emitter module can emit the detection beam from the surface. The receiver module can receive the echo beam on the surface. There are multiple ways to arrange the emitter module and receiver module on the same surface of the substrate 110, such as mounting a laser chip and a photodetector chip on a PCB board, or packaging a laser diode and a photodiode on the PCB board, or the like.

In some embodiments, one emitter module and one receiver module can be arranged on the same surface of the substrate 110, or multiple emitter modules and multiple receiver modules can be arranged on the same surface of the substrate 110. The specific numbers of emitter modules and receiver modules are not limited in the embodiments of this disclosure. It should be noted that when multiple emitter modules and multiple receiver modules are arranged on the same surface of the substrate, the emitter modules and receiver modules can be in a one-to-one correspondence, or one emitter module can correspond to multiple receiver modules, or multiple emitter modules can correspond to one receiver module. Some embodiments of this disclosure do not limit the correspondence between the emitter module and the receiver module, as long as an echo beam corresponding to a detection beam emitted by an emitter module can be received by a receiver module corresponding to the emitter module.

It should be understood that each module in the embodiments described in this disclosure can include one or more physical components in whole or in part. For example, a module can be implemented as a processor, a controller, a computer, or any form of hardware components. In some embodiments, based on different application scenarios, the emitter module can include an emitter, an emitter circuit, or other hardware components for emitting. The emitter can include an emission circuit, semiconductor laser, fiber laser, or the like. For example, the emitter can include a vertical-cavity surface-emitting laser (“VCSEL”), an edge-emitting laser (“EEL”), a distributed feedback laser (“DFB”), or the like. In some embodiments, the receiver module can include a receiver, a transceiver, a receiving circuit, or other hardware components for receiving. For example, the receiver module can be realized by a processor and a receiving computer program. The receiver can include a receiving circuit, an avalanche photodiode (“APD”), silicon photomultiplier (“SIPM”), single photon avalanche diode (“SPAD”), or the like. The types and numbers of the emitter module and receiver module are not limited in some embodiments of this disclosure.

In this disclosure, the terms “a”, “an”, and “the” are intended to represent singular or plural forms, unless expressly stated otherwise in the context. For example, without expressly stated otherwise in the context, “a transceiver” can refer to a single transceiver or a plurality of transceivers.

In some embodiments, the installing base 120 includes the first optical channel 121 and the second optical channel 122. The first optical channel 121 and the second optical channel 122 penetrate through the first end and the second end of the installing base 120. The substrate 110 is fixedly connected to the first end of the installing base 120. The emission lens module 130 and the receiving lens module 140 are fixedly connected to the second end of the installing base 120.

The first end and the second end of the installing base 120 are opposite to each other. The first optical channel 121 and the second optical channel 122 penetrate through the first end and the second end of the installing base 120. The installing base has a structure with both ends (e.g., the first end and the second end of the installing base 120) open. The first end and the second end of the installing base 120 can form assembly surfaces for assembling with other modules. The assembly surface is completely open and the assembly surface is a planar end surface, making the assembly surface easy to achieve high precision processing. There is no need to install any optical device inside the installing base 120. The first optical channel 121 and the second optical channel 122 inside the installing base 120 can provide spaces for beams to pass through. The interior of the installing base 120 do not need high precision processing. The overall processing cost of the installing base 120 can be lower.

The first end of the installing base 120 is used to fixedly connect the substrate 110. The second end of the installing base 120 is used to fixedly connect the emission lens module and the receiving lens module. The emitter module and the emission lens module correspond to two ends of the first optical channel 121 respectively. The receiver module and the receiving lens module correspond to two ends of the second optical channel 122 respectively.

A shape of a cross section of the first optical channel 121 and the second optical channel 122 can include one or more of triangles, hexagons, diamonds, circles, ellipses, rectangles, or the like. The shape of the cross section is not limited in some embodiments of this disclosure, as long as the shapes of the cross section of the first optical channel 121 and the second optical channel 122 can be compatible with the shapes of the emission lens module and the receiving lens module.

The first optical channel 121 and the second optical channel 122 are isolated from each other to separate an optical path of the detection beam from an optical path of the echo beam. This can effectively decrease or prevent the detection beam from directly entering into the receiver module within the LiDAR. A light shielding plate on the installing base 120 used to isolate the first optical channel 121 from the second optical channel 122 can be integrally processed with the installing base 120. The first optical channel 121 and the second optical channel 122 can be processed separately. Alternatively, a large optical channel can be processed inside the installing base 120, and then the large optical channel can be divided into the first optical channel 121 and the second optical channel 122 by arranging the light shielding plate in a middle area.

In some embodiments, still referring to FIGS. 1 and 2, the first end of the installing base 120 is substantially parallel to the second end of the installing base 120. A surface of the substrate 110 on which the emitter module and the receiver module are installed is tightly connected to the first end of the installing base 120. The detection beam emitted by the emitter module can directly enter into the emission lens module without being deflected. The echo beam shaped by the receiving lens module can directly enter into the receiver module without being deflected. An installing hole is provided at the first end of the installing base 120, and an installing hole is provided at corresponding position of the substrate 110. The substrate 110 can be securely connected with the installing base 120. The substrate 110 can be directly fixed to the installing base 120 by screw, glue, or the like.

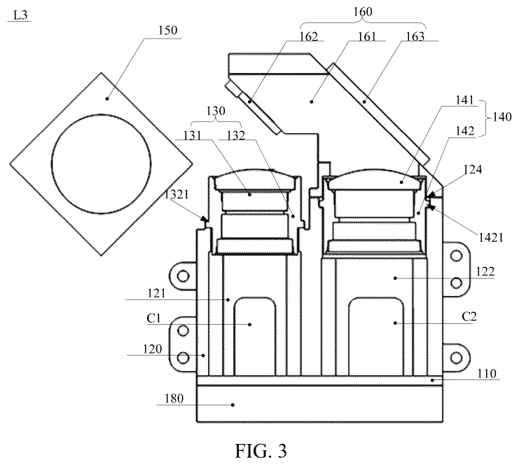

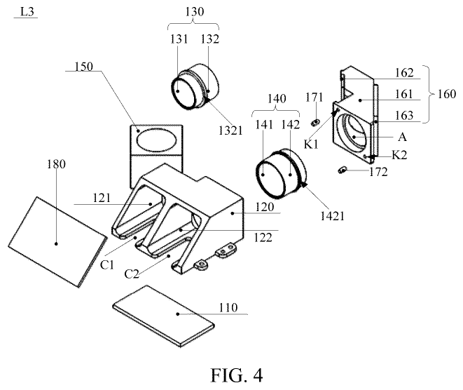

In some embodiments, for example, referring to FIGS. 3 and 4, the first end of the installing base 120 is substantially perpendicular to the second end. The installing base 120 also has a third end. Both the first optical channel 121 and the second optical channel 122 penetrate through the first end, the second end, and the third end of the installing base 120. There is an angle between a plane where the third end is located and a plane where the second end is located. There is an angle between the plane where the third end is located and a plane where the first end is located. The third end is designed inclined to an outer sidewall of the installing base 120. The third end is connected to the first end and opposite to the second end. The LiDAR L3 further includes a second reflective mirror module 180. The second reflective mirror module 180 is mounted on the third end of the installing base 120. The detection beam emitted by the emitter module can be deflected by the second reflective mirror module 180 before being incident on the emission lens module, and the echo beam shaped by the receiving lens module can be deflected by the second reflective mirror module 180 before being incident on the receiver module.

For example, referring to FIG. 4, from a current perspective in FIG. 4, the second end is located at a front side of the installing base 120 close to the emission lens module 130 and the receiving lens module 140 (along an inward direction of the paper). The third end is located at a rear side of the installing base 120 close to the second reflective mirror module 180 (along an outward direction of the paper). The first end is located at a bottom side of the installing base 220 close to the substrate 110 (along a downward direction of the paper). For example, the substrate 110 is installed onto the bottom side of the installing base 120.

Still referring to FIG. 4, two semi-open through hole structures C1 and C2 are arranged at the first end of the installing base 130. The detection beam emitted by the emitter module can be transmitted to the second reflective mirror module 180 through the through hole C1. The echo beam deflected by the second reflective mirror module 180 can be transmitted to the receiver module through the through hole C2.

In some embodiments referring to FIGS. 1 and 2, the size of the substrate 110 can be compatible with a size of the first end. In the LiDAR with a structure referring to FIGS. 3 and 4, the size of the substrate 110 is compatible with a size of the bottom surface of the installing base 120. The size of the substrate can be made larger. The main board of the LiDAR can also be integrated onto the substrate 110.

In some embodiments, a size of the substrate 110 in an extension direction of the surface of the substrate 110 on which the emitter module and the receiver module are installed can be larger than the cross section size of the first end of the installing base 120. The optical path at the substrate 110 can be completely enclosed. Less or no stray light can be irradiated from the receiver module. The detection signal-to-noise ratio can be improved or ensured.

In some embodiments, the emission lens module 130 and the receiving lens module 140 are separate structural components respectively and can be respectively designed as axisymmetric structures.

The emission lens module 130 includes an emission lens 131 and an emission lens barrel 132. The emission lens 131 can correspond to the emitter module and can be used to collimate the detection beam. The emission lens barrel 132 has an axisymmetric structure and can be used to fix the emission lens. A first protrusion structure 1321 is provided on the outer circumference of the emission lens barrel.

In some embodiments, for example, referring to FIGS. 1-6, the emission lens 131 is arranged inside the emission lens barrel 132. A shape of a cross section of the emission lens barrel 132 is compatible with a shape of the emission lens 131. The process for manufacturing axisymmetric optical lenses is mature and the axisymmetric optical lenses are commonly used lenses. The emission lens barrel 132 has an axisymmetric structure. When the optical installing surface inside the emission lens barrel 132 is processed, the axisymmetric structure can be obtained by turning processes to improve or ensure processing precision. A radial length of the emission lens barrel 132 can be small as the emission lens barrel 132 only needed to install an emission lens group. This can provide more operational space when processing the interior of the emission lens barrel 132.

The outer circumference of the emission lens barrel 132 is provided with a first protrusion structure 1321. The emission lens module 130 can be connected and positioned to the installing base 120 through the first protrusion structure 1321.

In an optional example, referring to FIG. 1 and FIG. 2, the first protrusion structure 1321 is snapped into the second end of the installing base 120. For example, the first protrusion structure 1321 is directly snapped at a top position of the first optical channel 121. A portion of the structure of the emission lens module 230 is located inside the first optical channel 121 while another portion of the structure is located outside the first optical channel 121.

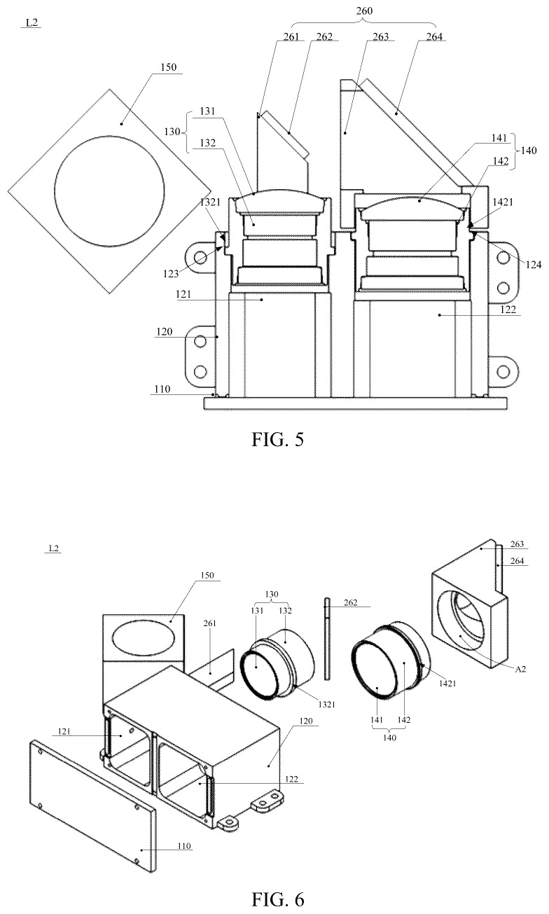

In an optional example, referring to FIG. 5 and FIG. 6, the installing base 120 further includes a first groove structure 123 arranged circumferentially on an inner wall of the end of the first optical channel 121. Through the cooperation of the first groove structure 123 and the first protrusion structure 1321, the emission lens barrel 132 is positioned to the first light channel 121.

For example, referring to FIGS. 1-6, the receiving lens module 140 can include a receiving lens 141 and a receiving lens barrel 142. The receiving lens 141 is arranged inside the receiving lens barrel 142. The receiving lens module 140, the receiving lens 141 and the receiving lens barrel 142 can be designed as an axisymmetric structure. An outer circumference of the receiving lens barrel 142 is provided with a second protrusion structure 1421. The receiving lens module 140 is connected and positioned to the installing base 120 through the second protrusion structure 1421.

In an optional example, for example, referring to FIG. 1, the installing base 120 further includes a second groove structure 124 arranged on an inner wall of the end of the second optical channel 122. Through the cooperation of the second protrusion structure 1421 and the second groove structure 124, the receiving lens barrel 142 is positioned to the second optical channel 122.

For example, the second protrusion structure 1421 on an outer circumference of the receiving lens barrel 142 is correspond to the second groove structure 124. By combining the second protrusion structure 1421 with the second groove structure 124, the receiving lens module 140 is fixedly arranged at an end of the second optical channel 122.

In some embodiments, the first protrusion structure 1321 is provided on the outer circumference of the emission lens module 130 and the second protrusion structure 1421 is provided on the outer circumference of the receiving lens module 140. By doing this, the emission lens module 130 and the receiving lens module 140 are easily snapped and positioned to the installing base 120 during the assembly process of the LiDAR without large assembly errors. The workload of alignment process can be reduced.

The first protrusion structure 1321 is circumferentially arranged in a middle area on an outer side of the emission lens module 130. The second protrusion structure 1421 is arranged in a middle area on an outer side of the receiving lens module 140. After the emission lens module 130 is assembled to the installing base 120, a part of a structure of the emission lens module 130 is located inside an optical channel, and another part of the structure of the emission lens module 130 is located outside the optical channel. After the receiving lens module 140 is assembled to the installing base 120, a part of a structure of the receiving lens module 140 is located inside an optical channel, and another part of the structure of the receiving lens module 140 is located outside the optical channel. The overall volume of the LiDAR can be reduced. A snapping between the emission lens module 130 and the installing base 120 can be achieved by the first protrusion structure 1321 arranged circumferentially in the middle area, and a snapping between the receiving lens module 140 and the installing base 120 can be achieved by the second protrusion structure 1421 arranged circumferentially in the middle area. The snapping way can be more stable and less prone to lateral deviation and skew, as compared with the way that the ends of the emission lens module 130 and the receiving lens module 140 are connected with the installing base 120. The stability of the overall performance can be improved or ensured in long-term use of the LiDAR.

In some embodiments, based on example structure of the installing base 120, different installing ways can be used for the installing base 120, the emission lens module 130, and the receiving lens module 140. In some embodiments, the structure of the installing base can be modified to fixedly arrange the emission lens module 130 inside the first optical channel 121 and fixedly arrange the receiving lens module 140 inside the second optical channel 122. In some embodiments, the structure of the installing base can be modified to fixedly arrange the emission lens module 130 outside the first optical channel 121 and fixedly arrange the receiving lens module 140 outside the second optical channel 122.

Based on the simplified LiDAR, to increase the accuracy of detection results of the LiDAR, it is preferred to adjust the positions of some modules (e.g., the emission lens module 130, the receiving lens module 140, the substrate 110, the first reflective mirror module 160, 260, the second reflective mirror module 180, or the like) of the LiDAR in an installing process to achieve the alignment of the emitter and receiver of the LiDAR.

In some embodiments, the emission lens module 130 and the receiving lens module 140 are separated from the installing base 120. And a first adjustable gap can be provided between the emission lens module 130 and a side wall of the first optical channel 121, and a second adjustable gap can be provided between the receiving lens module 140 and a side wall of the second optical channel 122.

In some embodiments, during assembling the LiDAR, the substrate 110 can be directly fixed to the installing base 120. Through the first adjustable gap, the emission lens module 130 can be moved on a plane perpendicular to an optical axis to adjust a relative position between the emission lens module 130 and the first optical channel 121. The echo beam can be directed to a preset position on receiver module. Optionally, through the second adjustable gap, the receiving lens module 140 can be moved on the plane perpendicular to the optical axis to adjust a relative position between the receiving lens module 140 and the second optical channel 122. The echo beam can be directed to a preset position on the receiver module. Optionally, the relative position between the emission lens module 130 and the first optical channel 121 and the relative position between the receiving lens module 140 and the second optical channel 122 can be adjusted simultaneously to enable the echo beam to be directed to the preset position of the receiver module. By adjusting the emission lens module 130 and/or the receiving lens module 140, the alignment of the emitter and receiver of the LiDAR can be achieved.

In some embodiments, the LiDAR further includes a first reflective mirror module 160, 260. The first reflective mirror module 160, 260 is arranged at the second end of the installing base 120. The first reflective mirror module 160, 260 is used to change the transmission direction of the detection beam collimated by the emission lens module 130 to deflect the detection beam to the scanner module 150; and to change the transmission direction of the echo beam deflected by the scanner module 150 to deflect the echo beam to the receiving lens module 140.

In some embodiments, the first reflective mirror module 160, 260 can be mutually separate from the installing base 120, the emission lens module 130 and the receiving lens module 140. The structure of the first reflective mirror module 160, 260 can be flexibly designed and adjusted.

In some embodiments, still referring to FIGS. 1 and 2, the first reflective mirror module 160 includes a first installing bracket 161, a first partial reflective mirror 162, and a first receiving reflective mirror 163.

The first installing bracket 161 is arranged at the second end of the installing base 120 and can have a hollow channel A, the hollow channel A can allow the echo beam to pass through.

The first partial reflective mirror 162 is arranged on a first side of the first installing bracket 161 and can change the transmission direction of the detection beam collimated by the emission lens module 130 to deflect the detection beam to the scanner module 150. And the first partial reflective mirror 162 can allow the echo beam to pass through to transmit the echo beam to the first receiving reflective mirror 163.

The first receiving reflective mirror 163 is arranged on a second side of the first installing bracket 161 and can change the transmission direction of the echo beam to deflect the echo beam to the receiving lens module 140.

The first side of the first installing bracket 161 and the second side of the first installing bracket 161 are opposite sides of the first installing bracket 161.

In some embodiments, the detection beam emitted by the emitter module can incident to the first partial reflective mirror 162 after being collimated by the emission lens module 130. The first partial reflective mirror 162 can change the transmission direction of the detection beam to make the detection beam can be transmitted to the scanner module 150. The scanner module 150 can change the transmission direction of the detection beam again, and the detection beam can be transmitted to the external space of the LiDAR.

When the detection beam detects an object, the detection beam can be reflected by the surface of the object to generate the echo beam corresponding to the detection beam. The echo beam can be directed back to the scanner module 150 along a transmission path of the detection beam. The scanner module 150 can change the transmission direction of the echo beam. The first side and the second side are two opposite sides of the first installing bracket 161, allowing the echo beam to be transmitted to the first partial reflective mirror 162 and reach the first receiving reflective mirror 163 after passing through the first partial reflective mirror 162. The first receiving reflective mirror 163 can change the transmission direction of the echo beam, and the echo beam can be transmitted to the receiving lens module 140. After the echo beam is shaped by the receiving lens module 140, the echo beam can be transmitted to the corresponding receiver module. A detection process can be complete.

The first reflective mirror module 160 can use an integrated first installing bracket 161. The first partial reflective mirror 162 and the first receiving reflective mirror 163 can be arranged on opposite the first side and the second side sides of the first installing bracket 161. Space utilization of the first installing bracket can be improved and the number of structural components can be reduced. And the precise of the relative position between the first partial reflective mirror 162 and the first receiving reflective mirror 163 can be improved or ensured. The first side for bearing the first partial reflective mirror 162 and the second side for bearing the first receiving reflective mirror 163 as well as a side of the first installing bracket 161 corresponding to the installing base 120 can be used as assembling surfaces. The assembling surfaces need to be processed with high precision. The three assembling surfaces are completely open planes, and thus the processing with high precision can be easily achieved. The first installing bracket 161 can have a hollow channel inside, and the hollow channel has three ends in connection with the outside, namely, the first side, second side and the side of the first installing bracket 161 corresponding to the installing base 120. The hollow channel is only used to provide a passage space for a light beam without any optical installing surfaces arranged inside, which makes the hollow channel easy to achieve high precision processing.

In some embodiments, various methods can be used to fixedly install the first installing bracket onto the installing base.

As an example, referring to FIG. 2, installing holes K1 and K2 are provided at one end of the first installing bracket 161 close to the installing base 120, and the installing base 120 can also be provided with installing holes (not shown in FIG. 2) corresponding to the installing holes K1 and K2. The first installing bracket 161 and the installing base 120 can be connected by connecting the installing holes K1 and K2 of the first installing bracket 161 with the installing holes of the installing base 120 through a positioning module (e.g., positioning pins 171 and 172 shown in FIG. 2, or the like).

It can be understood that the number and distribution of the above installing holes (e.g., the installing holes of the first installing bracket 161, the installing holes of the installing base 120) are an example. In some embodiments, the number and positions of the installing holes can be flexibly set based on actual needs, and some embodiments of this disclosure do not make limitation on it. It can also be understood that the installing base 120 can be fixedly connected to the substrate 110 by using an installing hole and a positioning pin.

In some embodiments, the first installing bracket 161 and the installing base 120 can be connected by using other connection methods such as fasteners, adhesives, or the like. Some embodiments of this disclosure do not make limitation on the example connection method.

In some embodiments, the first partial reflective mirror 162 can be fixedly installed onto the first side of the first installing bracket 161 using fasteners or adhesives, or the like. When connected by adhesive, the first installing bracket 161 can include an adhesive injection hole arranged on the first side. In some embodiments, the first partial reflective mirror 162 can include a plane reflective mirror, a cylindrical reflective mirror, or a non-spherical curvature reflective mirror, or the like. In some embodiments, the first partial reflective mirror 162 can include a pinhole reflector, a partially transmissive and partially reflective mirror, polarization beam splitter (“PBS”), beam splitter, or the like.

The first receiving reflective mirror can be fixedly installed onto the second side of the first bracket using fasteners or adhesives, or the like. When connected by adhesive, the first installing bracket can include an adhesive injection hole arranged on the second side, and the first receiving reflective mirror can include at least one of the following: a plane reflective mirror, a cylindrical reflective mirror, or a non-spherical curvature reflective mirror.

It can be understood that the structure of the first reflective mirror module in the above embodiments is only an example. In some embodiments, the first reflective mirror module can be modified or expanded to obtain various different structures of the first reflective mirror module. The specific shape of the first reflective mirror module is not limited in some embodiments of this disclosure, as long as the first reflective mirror module can be fixedly installed onto the installing base.

For example, as shown in FIGS. 1 and 2, the first installing bracket 161 in the first reflective mirror module 160 has an integrally molded structure, and the first partial reflective mirror 162 and the first receiving reflective mirror 163 are respectively arranged on the first side and the second side of the first installing bracket 161.

In some embodiments, the first reflective mirror module can include multiple installing brackets, and the emission lens module and the receiving lens module can be arranged on different installing brackets.

FIG. 5 shows a schematic diagram illustrating a profile structure of another example LiDAR, consistent with some embodiments of this disclosure. FIG. 6 shows a schematic diagram illustrating an explosion structure of another example LiDAR of FIG. 5, consistent with some embodiments of this disclosure. Referring to FIGS. 5 and 6, a difference between a LiDAR L2 shown in FIGS. 5 and 6 and the LiDAR L1 as described includes that a second partial reflective mirror 262 and a second receiving reflective mirror 264 of the LiDAR L2 shown in FIGS. 5 and 6 are arranged on different installing brackets.

For example, referring to FIGS. 5 and 6, the first reflective mirror module 260 includes a second installing bracket 261, the second partial reflective mirror 262, a third installing bracket 263, and the second receiving reflective mirror 264.

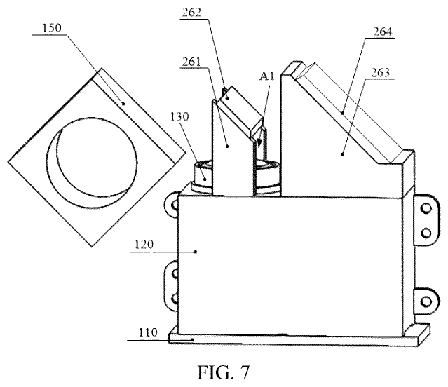

FIG. 7 shows a schematic diagram illustrating an example alignment of a LiDAR, consistent with some embodiments of this disclosure. Referring to FIG. 7, the second installing bracket 261 is arranged at the second end of the installing base 120 and has a first hollow structure A1. The first hollow structure A1 can be used to allow the detection beam to pass through.

Still referring to FIG. 7, the second partial reflective mirror 262 is arranged at an end of the first hollow structure A1 away from the substrate 110. And the second partial reflective mirror 262 can be used to change the transmission direction of the detection beam collimated by the emission lens module 130 to deflect the detection beam to the scanner module 150, and to allow the echo beam to pass through to transmit the echo beam to the second receiving reflective mirror 264.

Still referring to FIG. 7, the third installing bracket 263 is arranged at the second end of the installing base 120 and has a second hollow structure A2. The second hollow structure A2 can be used to allow the echo beam to pass through.

Still referring to FIG. 7, the second receiving reflective mirror 264 is arranged at an end of the second hollow structure A2 away from the substrate 110, and can be used to change the transmission direction of the echo beam to deflect the echo beam to the receiving lens module 140.

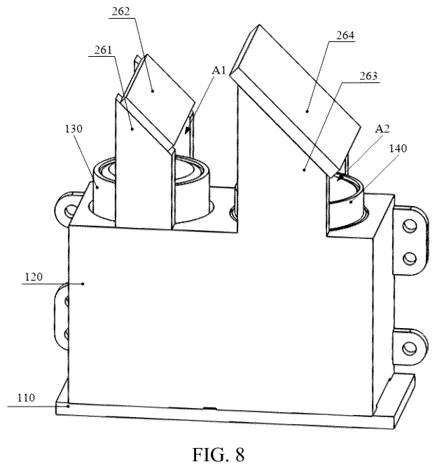

FIG. 8 shows a schematic diagram illustrating another example alignment of a LiDAR, consistent with some embodiments of this disclosure. It can be understood that the second installing bracket 261 and the third installing bracket 263 can have different structure designs, such as the integrated structure (e.g., the integrated structure as shown in FIG. 6), or separate structures (e.g., as separate structures shown in FIG. 8). This disclosure does not make limitation to specific structures of the second installing bracket 261 and the third installing bracket 263.

In some embodiments, after the detection beam emitted by the emitter module is collimated by the emission lens module 130, the detection beam can be incident on the second partial reflective mirror 262 through the first hollow structure. And the second partial reflective mirror 262 can change the transmission direction of the detection beam. The detection beam can be transmitted to the scanner module 150. The scanner module 150 can further change a transmission direction of the detection beam again, and the detection beam can be transmitted to the outside.

When the detection beam detects an object, the detection beam reflected on the surface of the object, and the echo beam corresponding to the detection beam is generated. The echo beam can be directed back to the scanner module 150 along the transmission path of the detection beam. The scanner module 150 can change the transmission direction of the echo beam. The echo beam can be transmitted to the second partial reflective mirror 262 and be incident on the second receiving reflective mirror 264 after passing through the second partial reflective mirror 262. The second receiving reflective mirror 264 can change a transmission direction of the echo beam, and the echo beam can be transmitted to the receiving lens module 140 through the second hollow structure A2. After the echo beam is shaped by the receiving lens module 140, the echo beam can be transmitted to the corresponding receiver module. A detection process can be completed.

Based on the first reflective mirror module with the above structure (e.g., the first reflective mirror module 160 shown in FIGS. 5 and 6), the second partial reflective mirror and the second receiving reflective mirror can be fixed by using two separated installing brackets, the structural design for the installing brackets can be more flexible and concise. The first hollow structure A1 and the second hollow structure A2 can be processed more easily. The size of each installing bracket can also be designed smaller, which provides a greater operation space for adjusting the positions of the emission lens module 130 and the receiving lens module 140.

The second partial reflective mirror 262 can be arranged on the second installing bracket 261 and the second receiving reflective mirror 264 can be arranged on the third installing bracket 263. A position and attitude of the second installing bracket 261 relative to the installing base 120 and/or a position and attitude of the second partial reflective mirror 262 relative to the second installing bracket 261 can be adjusted to direct the echo beam to a preset position of the receiver module; and/or a position and attitude of the third installing bracket 263 relative to the installing base 120 and/or a position and attitude of the second receiving reflective mirror 264 relative to the third installing bracket 263 can be adjusted to direct the echo beam to the preset position of the receiver module. The alignment of the emitter and receiver of the LiDAR can be achieved. On the other hand, the positions of the second partial reflective mirror 262 and the second receiving reflective mirror 264 can be flexibly arranged. This allows the LiDAR to adapt to different detection scenarios and have greater flexibility and universality.

This disclosure also provides an alignment method for a LiDAR, which is explained as follows through some examples.

In some embodiments, the LiDAR can include a substrate 110, an installing base 120, an emission lens module 130, a receiving lens module 140, a scanner module 150 and a first reflective mirror module 160, 260. The substrate 110 can include an emitter module and a receiver module arranged on a same surface of the substrate 110. The installing base 120 can include a first optical channel 121 and a second optical channel 122. The first optical channel 121 and the second optical channel 122 can be isolated from each other. For the example structure and operation principle of the LiDAR, the previous examples can be referred to, such as the LiDAR L1, L2, L3 shown in FIGS. 1-8, which are not be repeated herein.

In some embodiments, a first adjustable gap can be arranged between the emission lens module 130 and a side wall of the first optical channel 121; and/or a second adjustable gap can be arranged between the receiving lens module 140 and a side wall of the second optical channel 122. The alignment method can include: a relative position between the emission lens module 130 and the first optical channel 121 being adjusted to direct the echo beam to a preset position of the receiver module; and/or a relative position between the receiving lens module 140 and the second optical channel 122 being adjusted to direct the echo beam to the preset position of the receiver module.

In some embodiments, different alignment methods can align the LiDAR based on the structure of the LiDAR.

For example, a first alignment method can include: the substrate 110 and the first reflective mirror module 160, 260 being fixedly installed onto the installing base 120 respectively. The receiving lens module 140 being fixedly installed inside the second optical channel 122 of the installing base 120. The emission lens module 130 being initially snapped to the second end of the installing base 120 to make the emission lens module 130 located inside the first optical channel 121. There is a first adjustable gap between the emission lens module 130 and the first optical channel 121. The emitter module can be driven to emit a detection beam. Whether the echo beam corresponding to the detection beam is directed to the preset position of the receiver module can be monitored. The preset position can be a location of a detector corresponding to a laser of a channel. When it is monitored that the echo beam is directed to the preset position of the receiver module, the emission lens module 130 can be fixedly installed onto the second end of the installing base 120. When it is monitored that the echo beam is not directed to the preset position of the receiver module, the relative position between the emission lens module 130 and the first optical channel 121 can be adjusted until it is monitored that the echo beam is directed to the preset position of the receiver module.

As another example, a second alignment method can include: the substrate 110 and the first reflective mirror module 160, 260 being fixedly installed onto the installing base 120 respectively. The emission lens module 130 being fixedly installed inside the first optical channel 121 of the installing base. The receiving lens module 140 being initially snapped to the second end of the installing base 120 to make the receiving lens module 140 located inside the second optical channel 122. There is a second adjustable gap between the receiving lens module 140 and the second optical channel 122. The emitter module can be driven to emit a detection beam. Whether the echo beam corresponding to the detection beam is directed to the preset position of the receiver module can be monitored. When it is monitored that the echo beam is directed to the preset position of the receiver module, the receiving lens module 140 can be fixedly installed onto the second optical channel 122 of the installing base. When it is monitored that the echo beam is not directed to the preset position of the receiver module, the relative position between the receiving lens module 140 and the second optical channel 122 can be adjusted until it is monitored that the echo beam is directed to the preset position of the receiver module.

As yet another example, a third alignment method can include: the relative position between the emission lens module 130 and the first optical channel 121, and the relative position between the receiving lens module 140 and the second optical channel 122 being simultaneously adjusted. As an example, the third alignment method can include steps or operations similar to the steps or operations included in the first alignment method or the second alignment method as described herein. Some embodiments of this disclosure provide additional alignment methods for the LiDAR. Some examples are described as follows in combination with the attached drawings.

In some embodiments, the LiDAR can include a substrate 110, an installing base 120, an emission lens module 130, a receiving lens module 140, a scanner module 150 and a first reflective mirror module 260. The substrate 110 can include an emitter module and a receiver module arranged on a same surface of the substrate 110. The installing base 120 can include a first optical channel 121 and a second optical channel 122. The first optical channel 121 and the second optical channel 122 can be isolated from each other. The first reflective mirror module 260 can include a second installing bracket 261, a second partial reflective mirror 262, a third installing bracket 263, and a second receiving reflective mirror 264. For the specific structure and operation principle of the LiDAR, the previous examples can be referred to, such as the LiDAR L2 shown in FIGS. 5-8, which are not be repeated herein.

The alignment method can include: a position and attitude of the second installing bracket 261 relative to the installing base 120 and/or a position and attitude of the second partial reflective mirror 262 relative to the second installing bracket 261 being adjusted to direct the echo beam to the preset position of the receiver module; and/or a position and attitude of the third installing bracket 263 relative to the installing base 120 and/or a position and attitude of the second receiving reflective mirror 264 relative to the third installing bracket 263 being adjusted to direct the echo beam to the preset position of the receiver module.

For example, the LiDAR can be aligned using a fourth alignment method. The fourth alignment method can include: the substrate 110, emission lens module 130, and receiving lens module 140 being fixedly installed onto the installing base 120 respectively; the second receiving reflective mirror 264 being fixedly mounted onto an optical bearing surface of the third installing bracket 263; the second partial reflective mirror 262 being fixedly mounted onto an optical bearing surface of the second installing bracket 261, and the third installing bracket 263 being fixedly installed onto the installing base 120. The second installing bracket 261 is moveable relative to the installing base 120. The emitter module can be driven to emit the detection beam. Whether the echo beam corresponding to the detection beam is directed to the preset position of the receiver module can be monitored. When it is monitored that the echo beam is directed to the preset position of the receiver module, the second installing bracket 261 can be fixedly installed onto the installing base 120. When it is monitored that the echo beam is not directed to the preset position of the receiver module, the position and attitude of the second installing bracket 261 relative to the installing base 120 can be adjusted until the echo beam is directed to the preset position of the receiver module.

Referring to FIG. 7, the position and attitude of the second installing bracket 261 relative to the installing base 120 can be adjusted by using the following method: the lateral position and/or tilt angle of the second installing bracket 261 relative to the installing base 120 being adjusted. When the adjustment is completed, the second installing bracket 261 can be fixed to the installing base 120 by using a fastener such as glue, screw, dowel, or the like.

For example, a fifth alignment method can include: the substrate 110, emission lens module 130, and receiving lens module 140 being fixedly installed onto the installing base 120 respectively; the second installing bracket 261 and the third installing bracket 263 being fixedly installed onto the installing base 120; the second receiving reflective mirror 264 being fixedly mounted onto the optical bearing surface of the third installing bracket 263, while reserving a moveable space for the second partial reflective mirror 262 relative to the optical bearing surface of the second installing bracket 261. The emitter module can be driven to emit the detection beam. Whether the echo beam corresponding to the detection beam is directed to the preset position of the receiver module can be monitored. When it is monitored that the echo beam is directed to the preset position of the receiver module, the second partial reflective mirror 262 can be fixedly installed onto the second installing bracket 261. When it is monitored that the echo beam is not directed to the preset position of the receiver module, the position and attitude of the second partial reflective mirror 262 relative to the second installing bracket 261 can be adjusted until the echo beam is directed to the preset position of the receiver module.

Referring to FIG. 7, the position and attitude of the second partial reflective mirror 262 relative to the second installing bracket 261 can be adjusted by using the following method: the position or tilt angle of the second partial reflective mirror 262 relative to the optical bearing surface of the second installing bracket 261 being adjusted. When the adjustment is completed, the second partial reflective mirror 262 can be fixed to the optical bearing surface of the second installing bracket 261 by using a fastener such as glue, or the like.

For example, a sixth alignment method can include: the substrate 110, emission lens module 130, and receiving lens module 140 being fixedly installed onto the installing base 120 respectively; the second receiving reflective mirror 264 being fixedly mounted onto an optical bearing surface of the third installing bracket 263; the second partial reflective mirror 262 being fixedly mounted onto the optical bearing surface of the second installing bracket 261, and the second installing bracket 261 being fixedly installed onto the installing base 120. The third installing bracket 263 is movable relative to the installing base 120. The emitter module can be driven to emit the detection beam. Whether the echo beam corresponding to the detection beam is directed to the preset position of the receiver module can be monitored. When it is monitored that the echo beam is directed to the preset position of the receiver module, the third installing bracket 263 can be fixedly installed onto the installing base 120. When it is monitored that the echo beam is directed to the preset position of the receiver module, the position and attitude of the third installing bracket 263 relative to the installing base 120 can be adjusted until the echo beam is directed to the preset position of the receiver module.

Referring to FIG. 7, the position and attitude of the third installing bracket 263 relative to the installing base 120 can be adjusted by using the following method: adjusting the lateral position and tilt angle at which the third installing bracket 263 is installed onto the installing base 120. When the adjustment is completed, the third installing bracket 263 can be fixed to the installing base 120 by using a fastener such as glue and, screw, dowel, or the like.

For example, a seventh alignment method can include: the substrate 110, emission lens module 130, and receiving lens module 140 being fixedly installed onto the installing base 120 respectively; the second installing bracket 261 and the third installing bracket 263 being fixedly installed onto the installing base 120; the second partial reflective mirror 262 being fixedly mounted onto the optical bearing surface of the second installing bracket 261, while reserving a moveable space for the second receiving reflective mirror 264 relative to the optical bearing surface of the third installing bracket 263. The emitter module can be driven to emit the detection beam. Whether the echo beam corresponding to the detection beam is directed to the preset position of the receiver module can be monitored. When it is monitored that the echo beam is directed to the preset position of the receiver module, the second receiving reflective mirror 264 can be fixedly installed onto the third installing bracket 263. When it is monitored that the echo beam is not directed to the preset position of the receiver module, the position and attitude of the second receiving reflective mirror 264 relative to the third installing bracket 263 can be adjusted until the echo beam is directed to the preset position of the receiver module.

Referring to FIG. 7, the position and attitude of the second receiving reflective mirror 264 relative to the third installing bracket 263 can be adjusted by using the following method: the position and tilt angle of the second receiving reflective mirror 264 relative to the optical bearing surface of the third installing bracket 263 being adjusted. When the adjustment is completed, the second receiving reflective mirror 264 can be fixed to the optical bearing surface of the third installing bracket 263 by using a fastener such as glue, or the like.

With the LiDAR shown in this disclosure, the emitter module and the receiver module can be arranged on the same substrate. An installing base with a simple structure can integrate multiple devices, such as the substrate, the receiving lens module, the emission lens module and the first reflective mirror module of separate designs together. High precision processing of an assembly surface and an optical bearing surface can be realized for each of the separately designed receiving lens module, emission lens module, first reflective mirror module to achieve stable assembly with high precision. Through the separate structural design, the alignment method is more flexible, and the alignment of emitter and receiver can be realized by adjusting optical lenses, and thus there is no need to adjust the emitter module and receiver module. There is no need to reserve a movable space for the substrate during the assembling of the LiDAR, and the heat dissipation component can be directly fixed to the substrate, to realize tight fitting between the substrate and the emitter module and tight fitting between the substrate and the receiver module. Heat dissipation performance can be improved.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein indicates that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

It should be noted that the above description describes a plurality of embodiments of this disclosure, and if not conflicting, the various optional solutions described in respective embodiments can be combined with each other and cross-referenced, thus a variety of possible embodiments can be obtained, which can be considered as embodiments disclosed and disclosed in this disclosure.

Although embodiments of this disclosure are disclosed as above, this disclosure is not limited herein. Those skilled in the art can make various changes and modifications within the spirit and scope of this disclosure, therefore, the scope of protection of this disclosure shall be defined by the claims.

1-13. (canceled)

14. A LiDAR comprising:
a substrate comprising an emitter and a receiver, wherein the emitter, arranged on a surface of the substrate, is configured to emit a detection beam, and the receiver, arranged on the surface of the substrate, is configured to receive an echo beam reflected by an object;
an installing base comprising a first optical channel and a second optical channel, wherein the first optical channel is isolated from the second optical channel, the first optical channel is configured to penetrate through a first end and a second end of the installing base; and the second optical channel is configured to penetrate through the first end and the second end, wherein the detection beam is configured to pass through the first optical channel, the echo beam is configured to pass through the second optical channel, and the first end is configured to fixedly connect to the substrate;
an emission lens barrel connected to the second end;
a receiving lens barrel connected to the second end; and
a scanner configured to adjust a first direction of the detection beam and a second direction of the echo beam.

15. The LiDAR of claim 14, further comprising:
a first installing bracket;
a partial reflective mirror; and
a first reflective mirror,
wherein the first installing bracket, connected the second end, comprises a first hollow channel, and the partial reflective mirror is connected to the first end of the first installing bracket.

16. The LiDAR of claim 15, wherein the first reflective mirror is connected to a second side of the first installing bracket.

17. The LiDAR of claim 15, further comprising a second installing bracket,
wherein the second installing bracket, connected the second end, comprises a second hollow channel, and the first reflective mirror is connected to a third side of the second installing bracket.

18. The LiDAR of claim 14, further comprising a second reflective mirror,
wherein the installing base further comprises a third end, and the first optical channel is further configured to penetrate through the third end, the second optical channel is further configured to penetrate through the third end; and
wherein the second reflective mirror, connected to the third end, is configured to adjust the first direction of the detection beam to deflect the detection beam, and adjust the second direction of the echo beam to deflect the echo beam to the receiver.

19. The LiDAR of claim 18, wherein an angle is provided between a plane where the third end is located and a plane where the first end is located.

20. The LiDAR of claim 14, further comprising an emission lens,
wherein the emission lens is configured to collimate the detection beam, and the emission lens barrel configured to fix the emission lens is axisymmetric and comprises a first protrusion structure on an outer circumference of the emission lens barrel.

21. The LiDAR of claim 20, wherein the first protrusion structure is arranged in a middle area of the outer circumference of the emission lens barrel.

22. The LiDAR of claim 20, wherein the installing base further comprises a first groove provided circumferentially on an inner wall of the first optical channel, and the first groove is configured to cooperate with the first protrusion structure to position the emission lens barrel inside the first optical channel.

23. The LiDAR of claim 14, further comprising a receiving lens,
wherein the receiving lens is configured to shape the echo beam; and the receiving lens barrel configured to fix the receiving lens is axisymmetric and comprises a second protrusion structure on an outer circumference of the receiving lens barrel.

24. The LiDAR of claim 23, wherein the second protrusion structure is arranged in a middle area of the outer circumference of the receiving lens barrel.

25. The LiDAR of claim 23, wherein the installing base further comprises a second groove provided circumferentially on an inner wall of the second optical channel, and the second groove is configured to cooperate with the second protrusion structure to position the receiving lens barrel inside the second optical channel.

26. The LiDAR of claim 14, further comprising at least one of a first gap or a second gap,
wherein the first gap is provided between the emission lens barrel and a side wall of the first optical channel, and the second gap is provided between the receiving lens barrel and a side wall of the second optical channel.

27. The LiDAR of claim 14, wherein a size of the substrate along an extension direction of the surface is larger than a cross-sectional size of the first end.

28. The LiDAR of claim 14, wherein the substrate comprises a printed circuit board.

29. An alignment method for a LiDAR, wherein the LiDAR comprises:
a substrate comprising an emitter and a receiver, the emitter being arranged on a surface of the substrate and configured to emit a detection beam, and the receiver being arranged on the surface of the substrate and configured to receive an echo beam reflected by an object;
an installing base comprising a first optical channel and a second optical channel, the first optical channel being isolated from the second optical channel;
an emission lens barrel, a first gap being provided between the emission lens barrel and a side wall of the first optical channel;
a receiving lens barrel; and
a scanner,
the alignment method comprising:
adjusting a position of the emission lens barrel relative to the first optical channel to direct the echo beam to a predetermined position of the receiver.

30. An adjustment method for a LiDAR, wherein the LiDAR comprises:
a substrate comprising an emitter and a receiver, the emitter being arranged on a surface of the substrate and configured to emit a detection beam, and the receiver being arranged on the surface of the substrate and configured to receive an echo beam reflected by an object;
an installing base comprising a first optical channel and a second optical channel, the first optical channel being isolated from the second optical channel;
an emission lens barrel;
a receiving lens barrel. a second gap being provided between the receiving lens barrel and a side wall of the second optical channel; and
a scanner;
the alignment method comprising:
adjusting a position of the receiving lens barrel relative to the second optical channel to direct the echo beam to a predetermined position of the receiver.

31. An adjustment method for a LiDAR, wherein the LiDAR comprises:
a substrate comprising an emitter and a receiver, the emitter being arranged on a surface of the substrate and configured to emit a detection beam, and the receiver being arranged on the surface of the substrate and configured to receive an echo beam reflected by an object;
an installing base comprising a first optical channel and a second optical channel, the first optical channel being isolated from the second optical channel;
an emission lens barrel;
a receiving lens barrel;
a scanner;
a first reflective mirror;
a partial reflective mirror;
a first installing bracket; and
a second installing bracket,
the adjustment method comprising at least one of following:
adjusting a first position of the first installing bracket relative to the installing base;
adjusting a second position of the second installing bracket relative to the installing base;
adjusting a third position of the partial reflective mirror relative to the first installing bracket; or
adjusting a fourth position of the first reflective mirror relative to the second installing bracket.
